(19) United States
(12) Patent Application Publication
(10) Pub. No.: US 2023/0403510 A1
(43) Pub. Date: Dec. 14, 2023

(54) MULTIPLEXING APPLICATION CHANNELS ON ISOCHRONOUS STREAMS

(71) Applicant: Bose Corporation, Framingham, MA (US)

(72) Inventors: Rasmus Abildgren, Skørping (DK); Casper Stork Bonde, Støvring (DK)

(73) Assignee: Bose Corporation, Framingham, MA (US)

(21) Appl. No.: 18/330,720

(22) Filed: Jun. 7, 2023

Related U.S. Application Data
(60) Provisional application No. 63/366,041, filed on Jun. 8, 2022.

(51) Int. Cl. H04R 5/04

(52) U.S. Cl. CPC H04R 5/04; H04R 2420/07

(57) ABSTRACT

A first device is provided. The first device includes an audio source, a sensor, and a processor. The audio source generates audio data, and the sensor captures sensor data. The processor generates a data packet including an audio data set generated by the audio source and a sensor data set captured by the sensor. In some examples, the data packet may also include audio payload length data and/or sensor payload length data, audio channel identification data and/or sensor channel identification data, and/or audio time offset data and/or sensor time offset data. The audio data set may have a first lifetime and the sensor data set has a second lifetime longer than the first lifetime. The processor the transmits the data packet to a second device configured to reconstruct the audio data set and the sensor data set by demultiplexing the data packet.

### CROSS-REFERENCE TO RELATED APPLICATIONS

This application claims priority to U.S. Provisional Patent Application Ser. No. 63/366,041, filed on Jun. 8, 2022, and titled “Multiplexing Application Channels on Isochronous Streams,” which application is herein incorporated by reference in its entirety.

### BACKGROUND

Immersive audio rendered in virtual reality or augmented reality applications often requires the capture of multiple modes of data by a wearable audio device. This captured data must be wirelessly conveyed to a central device (such as a smartphone) for further processing to provide a user with an immersive audio experience.

### SUMMARY

The present disclosure is generally directed to transmitting two or more types of data over an isochronous stream via a multiplexing scheme. These types of data may include varieties of audio data (such as data captured by a microphone or data used by an acoustic transducer to generate audio) and/or non-audio data (such as data collected by different types of non-audio sensors). The multiplexing scheme may incorporate time offset values, allowing for time-accurate demultiplexing and reconstruction of the data transmitted over the isochronous stream. The multiplexing scheme may also incorporate data regarding the payload lengths of the data packet, as well a channel identification information regarding the source of the captured data. The isochronous stream may be a Connected Isochronous Stream (CIS) or a Broadcast Isochronous Stream (BIS), depending on the application. The sensor data can include a wide array of different data types, such as, for example, motion data captured by an inertial measurement unit (IMU).

Generally, in one aspect, a first device is provided. The first device includes an audio source. The audio source is configured to generate audio data.

The first device further includes a sensor. The sensor is configured to capture sensor data. According to an example, the sensor may be an inertial measurement unit (IMU). Further to this example, the sensor data may be motion data.

The first device further includes a processor. The processor is configured to generate a data packet. The data packet includes an audio data set generated by the audio source and a sensor data set captured by the sensor. According to an example, the data packet may further include audio payload length data and/or sensor payload length data. According to a further example, the data packet may further include audio channel identification data and/or sensor channel identification data. According to even further examples, the data packet further includes audio time offset data and/or sensor time offset data. According to yet further examples, the audio data set may have a first lifetime and the sensor data set may have a second lifetime longer than the first lifetime.

The processor is further configured to transmit the data packet to a second device. The second device is configured to reconstruct the audio data set and the sensor data set by demultiplexing the data packet. According to an example, the data packet may be transmitted via a Bluetooth Connected Isochronous Stream or a Bluetooth Broadcast Isochronous Stream.

According to an example, the first device may be a wearable audio device, and the second device is a central device. In an alternative example, the first device may be a central device, and the second device is a wearable audio device.

According to an example, the processor is further configured to (1) receive an audio data acknowledgment prior to the first lifetime expiring; (2) to generate a second data packet including the sensor data set; and (3) transmit the second data packet to the second device.

According to an example, the processor is further configured to (1) generate, via the audio source after the audio data set expires, a second audio data set; (2) generate, via the processor of the first device, a second data packet including the second audio data set and the sensor data set; and (3) transmit the second data packet to the second device. Further to this example, the processor may be further configured to (1) capture, via the sensor of the first device after the sensor data set expires, a second sensor data set; (2) generate a third data packet including the second audio data set and the second sensor data set; and (3) transmit the third data packet to the second device.

Generally, in another aspect, a method for transmitting data is provided. The method includes capturing, via an audio source of a first device, an audio data set.

The method further includes capturing, via a sensor of the first device, a sensor data set.

The method further includes generating, via a processor of the first device, a data packet. The data packet includes the audio data set and the sensor data set. According to an example, the data packet may further include audio payload length data and/or sensor payload length data. According to another example, the data packet may further include audio channel identification data and/or sensor channel identification data. According to a further example, the data packet may further include audio time offset data and/or sensor time offset data. According to even further examples, the audio data set has a first lifetime and the sensor data set has a second lifetime longer than the first lifetime.

The method further includes transmitting, via a transceiver of the first device, the data packet to a second device. According to an example, the data packet may be transmitted via a Bluetooth Connected Isochronous Stream or a Bluetooth Broadcast Isochronous Stream.

The method further includes receiving, via a transceiver of the second device, the data packet.

The method further includes reconstructing, via a processor of the second device, the audio data set and the sensor data set by demultiplexing the data packet.

According to an example, the method may further include (1) receiving, via the transceiver of the first device, an audio data acknowledgment prior to the first lifetime expiring; (2) generating, via the processor of the first device, a second data packet including the sensor data set; and (3) transmitting, via the transceiver of the first device, the second data packet to the central device.

According to an example, the method may further include (1) generating, via the audio source after the audio data set expires, a second audio data set; (2) generating, via the processor of the first device, a second data packet including the second audio data set and the sensor data set; and (3) transmitting, via the transceiver of the first device, the second data packet to the second device. Further to this example, the method may further include (1) capturing, via the sensor of the first device after the sensor data set expires, a second sensor data set; (2) generating, via the processor of the first device, a third data packet including the second audio data set and the second sensor data set; and (3) transmitting, via the transceiver of the first device, the third data packet to the second device.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a first embodiment of a system for wireless communication, in accordance with an example.

FIG. 2 is a schematic view of a second embodiment of a system for wireless communication, in accordance with an example.

FIG. 3 is a flow chart illustrating multiplexing and demultiplexing using Bluetooth protocols, in accordance with an example.

FIG. 4 illustrates a data packet including a connected isochronous stream (CIS) multiplex header, in accordance with an example.

FIG. 5 illustrates a data packet including a super service data unit (SSDU) having a CIS multiplex header, in accordance with an example.

FIG. 6 schematically illustrates an example Bluetooth isochronous adaption layer (ISOAL), in accordance with an example.

FIG. 7 schematically illustrates a further example Bluetooth ISOAL having an additional layer, in accordance with an example.

FIG. 8 is a flow diagram illustrating wireless communication between a wearable audio device and a central device, in accordance with an example.

FIG. 9 is a further flow diagram illustrating wireless communication between a wearable audio device and a central device, in accordance with an example.

FIG. 10 is a schematic diagram of a first device, in accordance with an example.

FIG. 11 is a schematic diagram of a second device, in accordance with an example.

FIG. 12 is a flow chart of a method for transmitting data, in accordance with an example.

FIG. 13 is another flow chart of a method for transmitting data, in accordance with an example.

FIG. 14 is a further flow chart of a method for transmitting data, in accordance with an example.

### DETAILED DESCRIPTION

The present disclosure is generally directed to transmitting two or more types of data over an isochronous stream via a multiplexing scheme. These types of data may include varieties of audio data (such as data captured by a microphone or data used by an acoustic transducer to generate audio) and/or non-audio data (such as data collected by various types of non-audio sensors). The multiplexing scheme may incorporate time offset values, allowing for time-accurate demultiplexing and reconstruction of the data transmitted over the isochronous stream. The multiplexing scheme may also incorporate data regarding the payload lengths of the data packet, as well a channel identification information regarding the source of the captured data.

In one non-limiting example, a wearable audio headset is used with a personal computer (PC) for gaming purposes. The headset may be connected to the PC via isochronous stream. The headset includes a microphone to capture the voice of the user as audio data, and a sensor, such as an inertial measurement unit (IMU), to capture the motion of the user's head as sensor data. A processor of the headset may multiplex the audio data with the sensor data, such that the headset transmits data packets containing both the audio data and the sensor data over the isochronous stream to the PC. The data packets also include time offset data indicating when each payload of audio data or sensor data was captured. The PC receives the data packets, demultiplexes the packets, and uses the time offsets to reconstruct the received audio and sensor data with proper timing. In further examples, other types of audio or non-audio data may be multiplexed and demultiplexed.

In another non-limiting example, an in-vehicle computing system of a vehicle is used with a pair of wireless earbuds worn by a driver of the vehicle. The wireless ear buds may be connected to the in-vehicle computing system via isochronous stream. The in-vehicle computing system includes an audio source to generate audio data corresponding to a navigation subsystem, an entertainment subsystem, or any other in-vehicle subsystem capable of generating audio. The in-vehicle computing system also includes a sensor configured to capture sensor data related to the motion (such as speed or direction) of the vehicle. A processor of the in-vehicle computing system may multiplex the audio data with the sensor data, such that the in-vehicle computing system transmits data packets containing both the audio and sensor data over the isochronous stream to the wireless ear buds. The data packets may also include time offset data indicating when each payload of audio data or sensor data was captured. The wireless ear buds receive the data packets, demultiplex the packets, and use the time offsets to reconstruct the received audio and sensor data with proper timing. Accordingly, the multiplexed audio and sensor data conveyed from the in-vehicle computing system to the wireless ear buds can be used to create an immersive audio experience incorporating the motion of the vehicle.

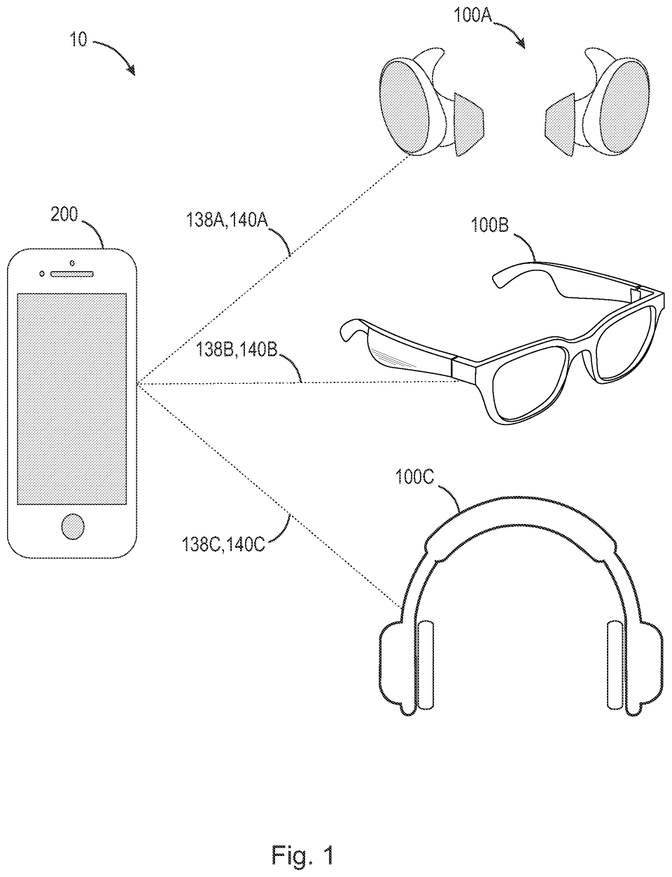

The term “wearable audio device”, as used in this application, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the ear cup or headphone. A wearable audio device can include components for wirelessly receiving audio signals. A wearable audio device can include components of an active noise reduction (ANR) system. Wearable audio devices can also include other functionality such as a microphone so that they can function as a headset. While FIG. 1 shows examples of an in-the-ear headphone form factor, an eyeglass form factor, and an over-the-ear headset, in other examples the wearable audio device can be an on-ear, around-ear, behind-ear, or near-ear headset. In some examples, the wearable audio device can be an open-ear device that includes an acoustic driver to radiate acoustic energy towards the ear while leaving the ear open to its environment and surroundings.

The term “connected isochronous stream” as used herein, in addition to including its ordinary meaning or its meaning known to those skilled in the art, is intended to refer to an isochronous data stream which utilizes a preestablished, point-to-point communication link over LE Audio between, e.g., a source device (which may also be known as a central or master device) and an audio device or a plurality of audio devices (which may also be known as a peripheral or slave device(s)). In other words, a connected isochronous stream can provide an isochronous audio stream which utilizes at least one established reliable communication channel and/or at least one acknowledged communication channel between the source device and any respective audio devices.

The term “broadcast isochronous stream” as used herein, in addition to including its ordinary meaning or its meaning known to those skilled in the art, is intended to refer to an isochronous data stream which does not require a preestablished communications link to be established between the source device sending data and the audio device receiving data and does not require acknowledgements or negative acknowledgements to be sent or received.

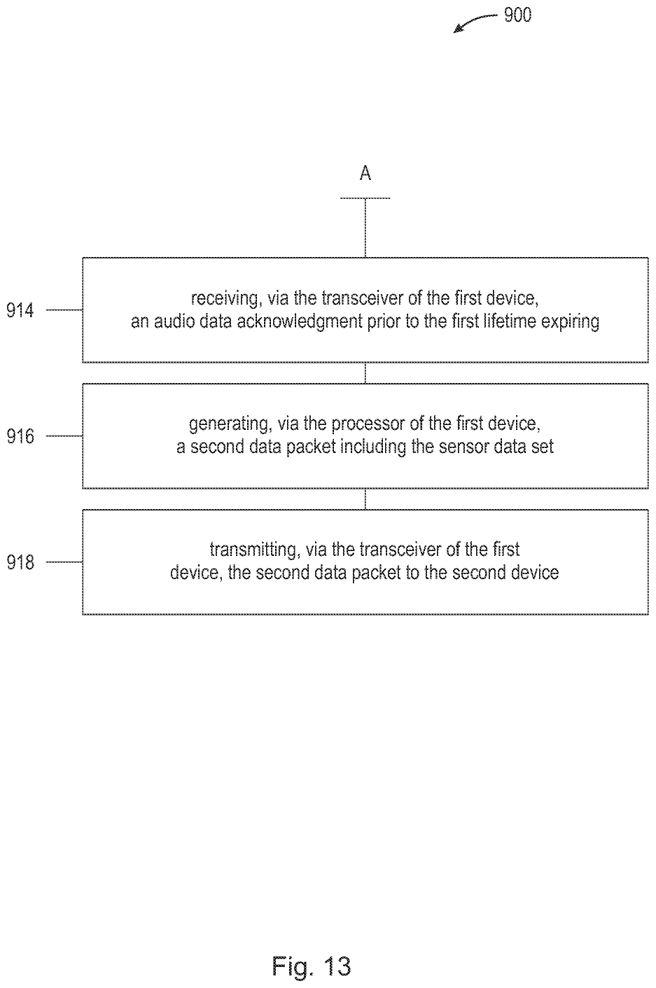

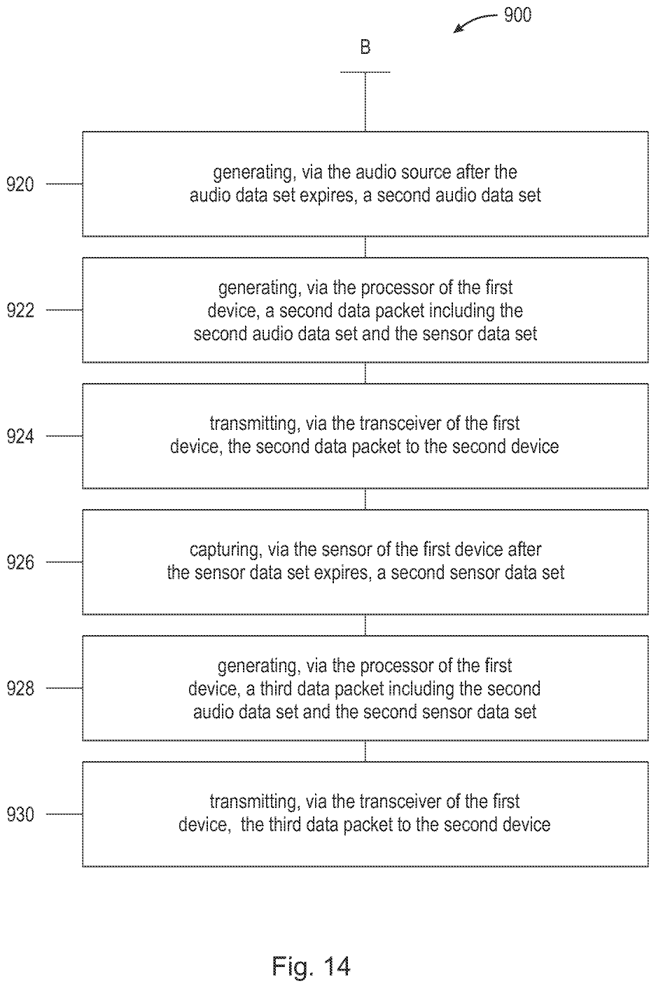

The following description should be read in view of FIGS. 1-14. FIG. 1 is a schematic view of the components of system 10 according to the present disclosure. In the non-limiting example of FIG. 1, the system 10 includes at least one first device 100 and a second device 200. As shown in FIG. 1, the least one first device 100 may be embodied as a wearable audio device, while second device 200 may be embodied as a central device. However, as will be demonstrated in subsequent examples, the first device 100 may instead be embodied as a central device, while the second device 200 may be embodied as a wearable audio device. Additionally, in some examples as illustrated in FIG. 1, system 10 includes a plurality of first devices 100A-100C (collectively referred to as “first devices 100” or “plurality of first devices 100”). Second device 200 is intended to be a device capable of establishing a wireless connection, e.g., wireless connection 138 (discussed below) with at least one first device 100. Although illustrated as a smartphone, it should be appreciated that second device 200 can be selected from at least one of a tablet, a smarthub, media hub, a stereo hub, a soundbar, a headphone case, or any device capable of sending or broadcasting wireless data (discussed below) to the at least one wearable device 100. Moreover, although illustrated as a pair of truly wireless earbuds 100A, an eyeglass form-factor device 100B, and an over-the-ear form-factor headset, it should be appreciated that first devices 100 can be selected from any devices capable of transmitting data to and/or receiving wireless data from the second device 200. In some examples, each first device 100 is intended to be a device capable of rendering audible acoustic energy based on the wireless data received from the second device 200, e.g., rendering audio data.

Each device of system 10, i.e., each first device 100 and second device 200, can use their respective communication modules and/or transceivers to establish one or more wireless connections 138A-138C (collectively referred to as “wireless connections 138”) between the second device 200 and each first device 100. Each wireless connection 138 can be used to send and/or receive wireless data via one or more wireless data streams 140A-140C (collectively referred to as “wireless data streams 140”). In some examples, these wireless connections 138 include establishing one or more data streams between the second device 200 and each first device 100, where each data stream is an isochronous data stream, e.g., a connected isochronous stream using LE Audio standard. In other examples, the wireless connections 138 include a broadcast isochronous stream, i.e., where second device 200 broadcasts data in one or more isochronous data streams that is/are received by one or more wireless audio devices 100. For example, second device 200 can be configured to generate, broadcast, or otherwise wirelessly transmit a wireless data stream 140 that is received by each first device 100. Alternatively, the first devices 100 may also transmit wireless data streams 140 via broadcast isochronous streams. The streams established over each wireless connection 138 can use various wireless data protocols, standards, or methods of transmission e.g., Bluetooth Low-Energy Protocols or the LE Audio standard.

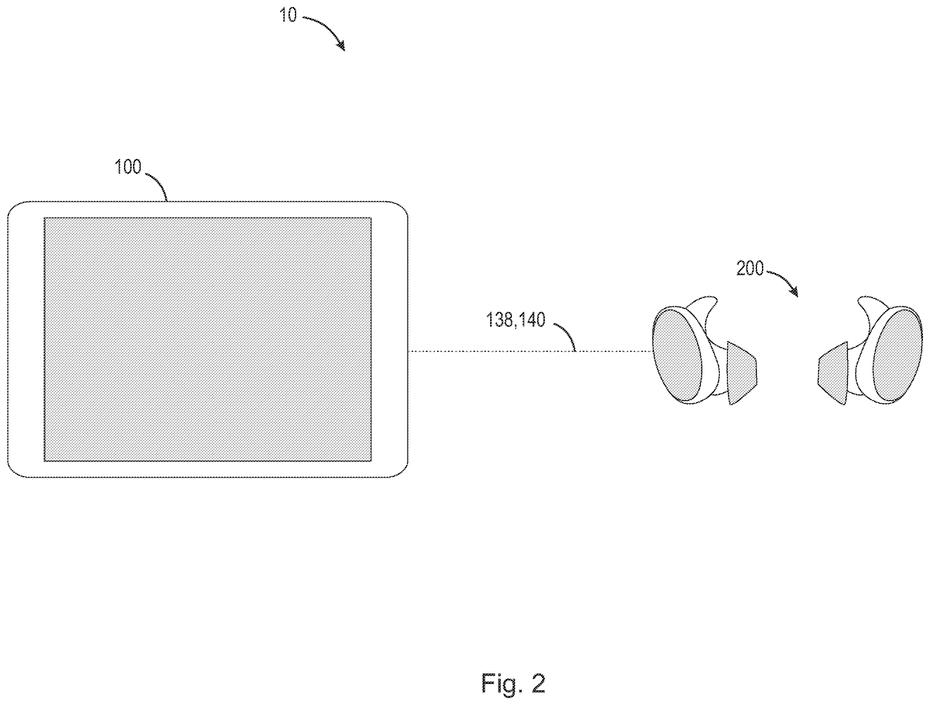

FIG. 2 illustrates a variation of the system 10 of FIG. 1. In the non-limiting example of FIG. 2, the first device 100 is embodied as a central device, while the second device 200 is embodied as a wearable audio device. In the example of FIG. 2, the first device 100 may be an in-vehicle computing system of a vehicle, incorporating aspects such as a navigation subsystem, an entertainment subsystem, and more. The second device 200 is embodied as a pair of wireless ear buds which may be worn by a driver of the vehicle. The wireless connection 138 enables the in-vehicle computing system to transmit a wireless data stream 140 to the wireless ear buds.

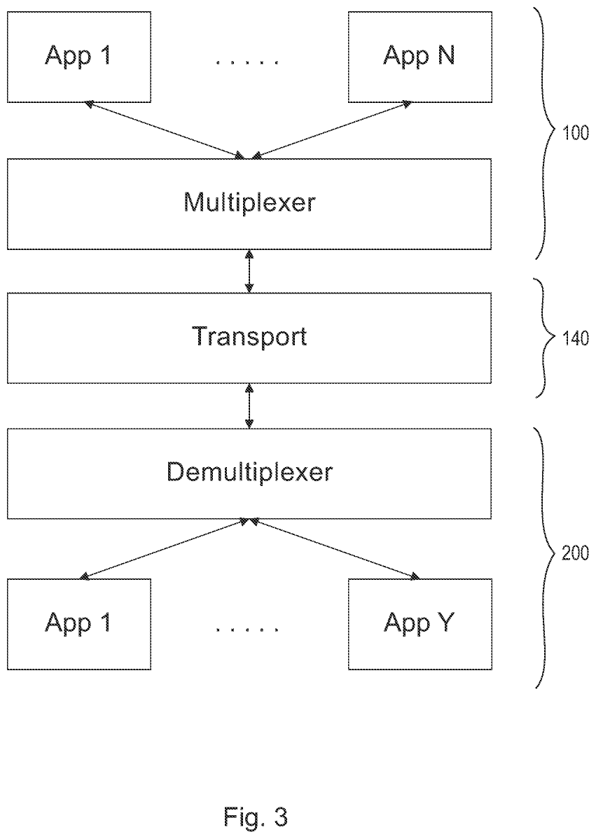

FIG. 3 illustrates an example of multiplexing and demultiplexing data transmitted over a wireless data stream 140, such as a Bluetooth isochronous stream. In this example, multiple applications of a first device 100, such as a wearable audio device, capture data. These applications may be associated with different sensors, such as microphones, motion sensors, etc. The multiplexer combines portions of the data collected by each application in single packets. The packets are transmitted via a transport 140, such as the isochronous stream, and are received by a second device 200, such as a PC or smartphone. The PC or smartphone reconstructs the data captured by the first device 100 and provides the data to the appropriate applications of the second device 200. In some examples, the multiplexing-demultiplexing scheme may be bidirectional, allowing the second device 200 to also transmit data packets containing multiple types of data to be demultiplexed by the first device 100.

The goal of the present disclosure is to create a scheme for isochronous channels, such as connected isochronous stream (CIS) channels, where each packet contains one more channel identifiers and length headers, such that the isochronous channel transmits packets containing data from multiple sources, such as data collected by microphones and motion sensors. The isochronous adaption layer (ISOAL) can be used to segment the packets.

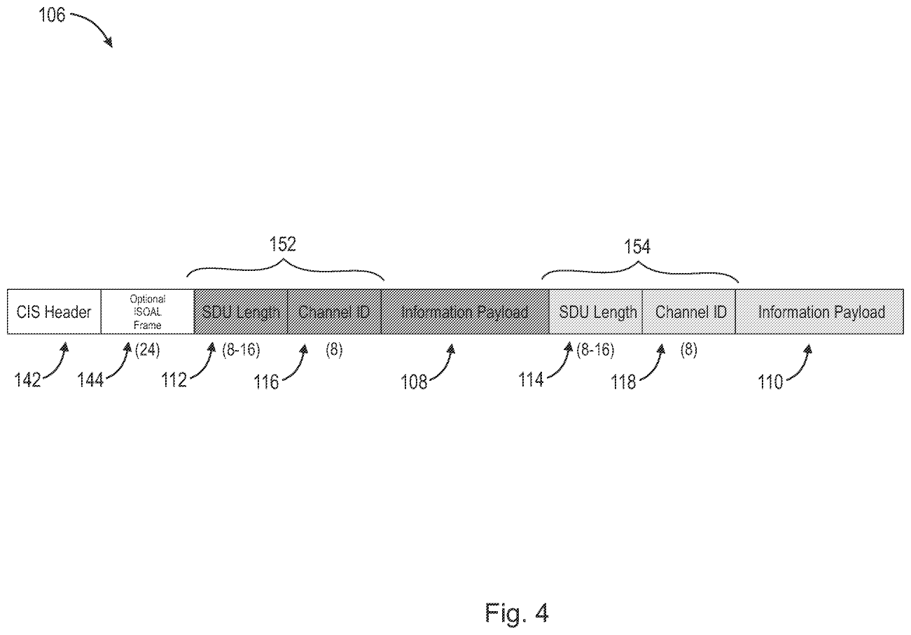

FIG. 4 illustrates a data packet 106 created by multiplexing using a basic CIS multiplexing header. The illustrated packet includes a CIS header 142, isochronous adaption layer (ISOAL) frame data 144, a first CIS multiplexing header 152, a first information payload 108, a second CIS multiplexing header 154, and a second information payload 110. In one example, the first CIS multiplexing header 152 and the first information payload 108 may correspond to audio data generated by an audio source 102. In some examples, the audio source may be a microphone configured to capture external audio. In other examples, the audio source 102 may be a hardware or software interface configured to receive audio information, such as a compressed media file from an entertainment or navigation subsystem, from other aspects of the first device 100. The second CIS multiplexing header 154 and the second information payload 110 may correspond to motion data captured by a non-audio sensor 104, such as a motion sensor. In some examples, the motion sensor may be an inertial measurement unit (IMU). The first CIS multiplexing header 152 includes a first service data unit (SDU) length 112 and first channel identification data 116, while the second CIS multiplexing header 154 includes a second SDU length 114 and first channel identification data 118. The service data unit (SDU) length 112, 114 indicates the length of the corresponding payload 108, 110, while the channel identification data 116, 118 indicates the application or data type corresponding to the payload. In the non-limiting example of FIG. 4, the ISOAL frame data 144 is 24 bits, the SDU length data 112, 114 is 8 to 16 bits, and the channel identification data 116, 118 is 8 bits.

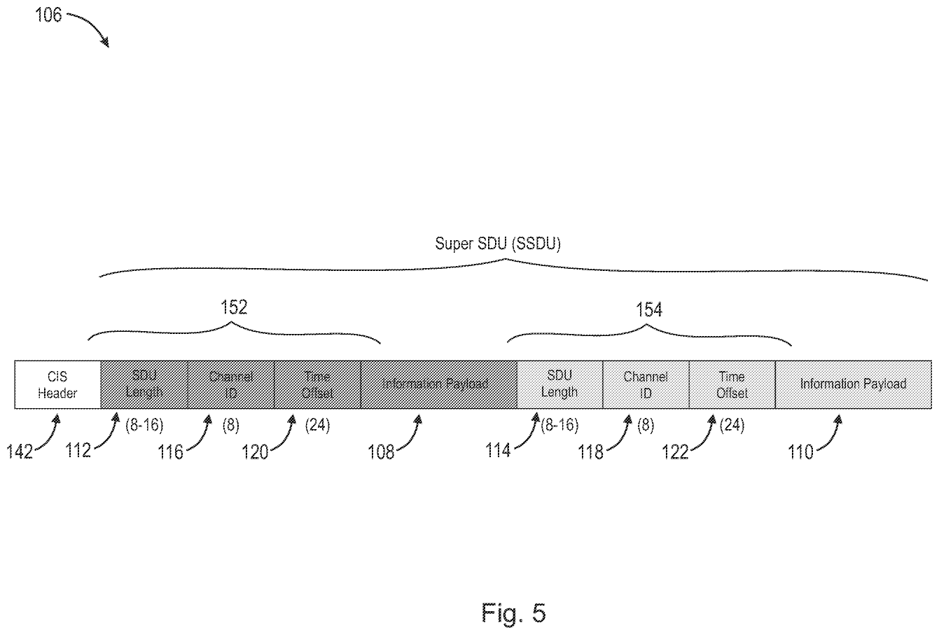

However, when transmitting payloads containing data from different sources (microphones, motion sensors, etc.) in the same packet, a timing offset is required to indicate when the data from each payload was captured. Due to different devices or different sensors of the same device having varying processing speeds or refresh rates, the data of each payload 108, 110 may have been captured at different times. Incorporating a timing offset corresponding to each payload allows a receiver to map all data back into their original time domain based on the reference clock of the isochronous channel. Example timing offsets 120, 122 are illustrated in FIG. 5 as components of the CIS multiplexing headers 152, 154 of a super SDU (SSDU). In FIG. 5, the timing offsets 120, 122 represent when the payloads 108, 110 were captured relative to an anchor point. The anchor point can correspond to the timing of a data packet being received by the first device 100 from the second device 200 in an isochronous event, or any other relevant point in time.

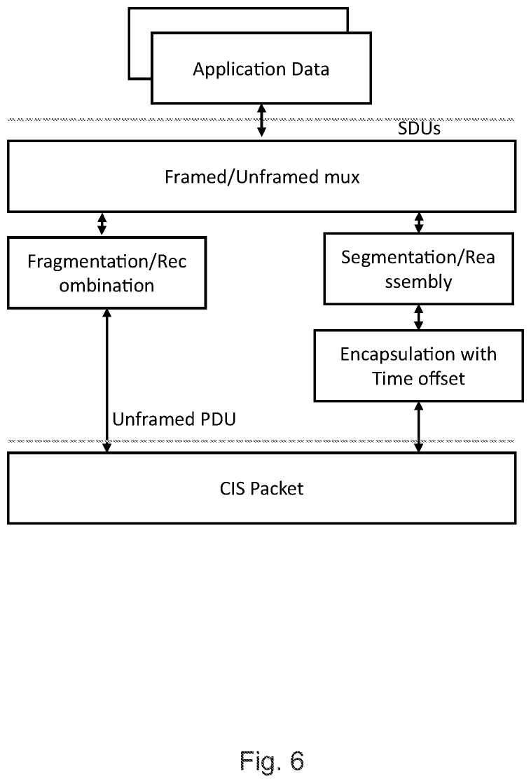

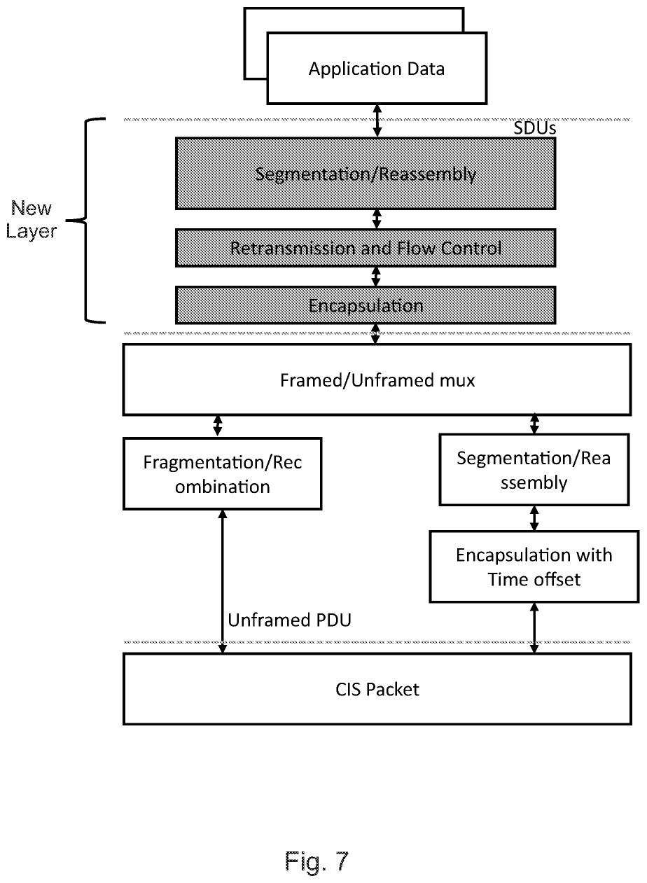

FIG. 6 illustrates the existing ISOAL architecture for creating a CIS packet from multiple types of application data, while FIG. 7 illustrates a new layer in this architecture for segmentation and reassembly, retransmission and flow control, and encapsulation. In particular, this new layer enables more efficient retransmission of payloads based on the lifetime of the data within the payload, as different types of data may have different lifetimes. For example, audio data may expire after 10 milliseconds (such as in low latency gaming applications), while sensor data (such as motion sensor data) may expire every 15 milliseconds. Thus, in this example, the data channel may be configured with a lifetime (or flush timeout) of 5 milliseconds, while repeating the audio data twice and the sensor data three times before refresh. Further, if the audio data is acknowledged as being received at the 8-millisecond mark, but the sensor data has not been acknowledged as received, the audio data will be removed but not replaced with new data until the 10-millisecond mark has been reached. During this period of time between 8 and 10 milliseconds, the isochronous channel will continue to transmit the packet with the sensor data only (without the audio data), saving energy by only retransmitting data not yet received.

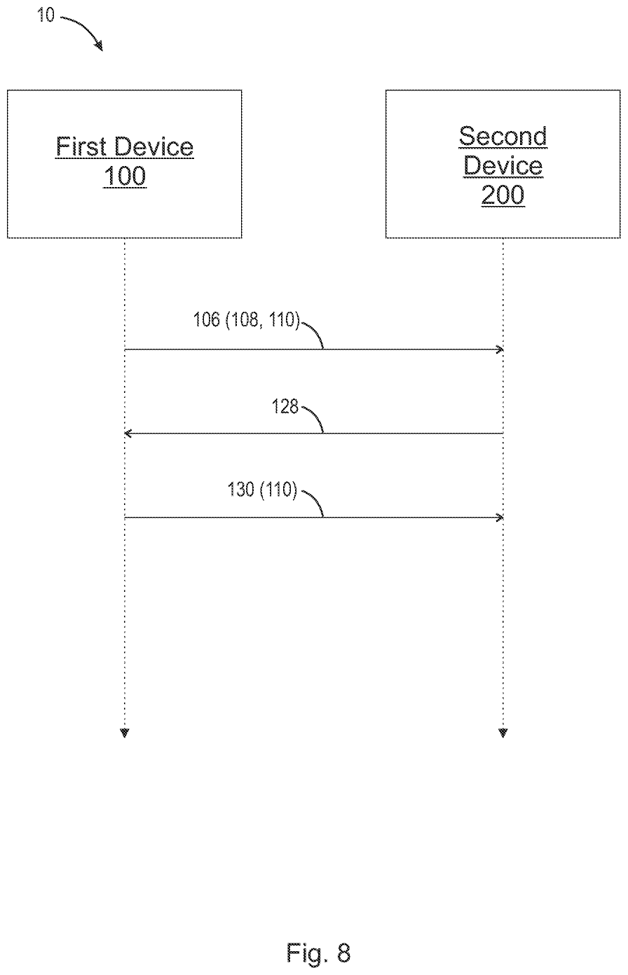

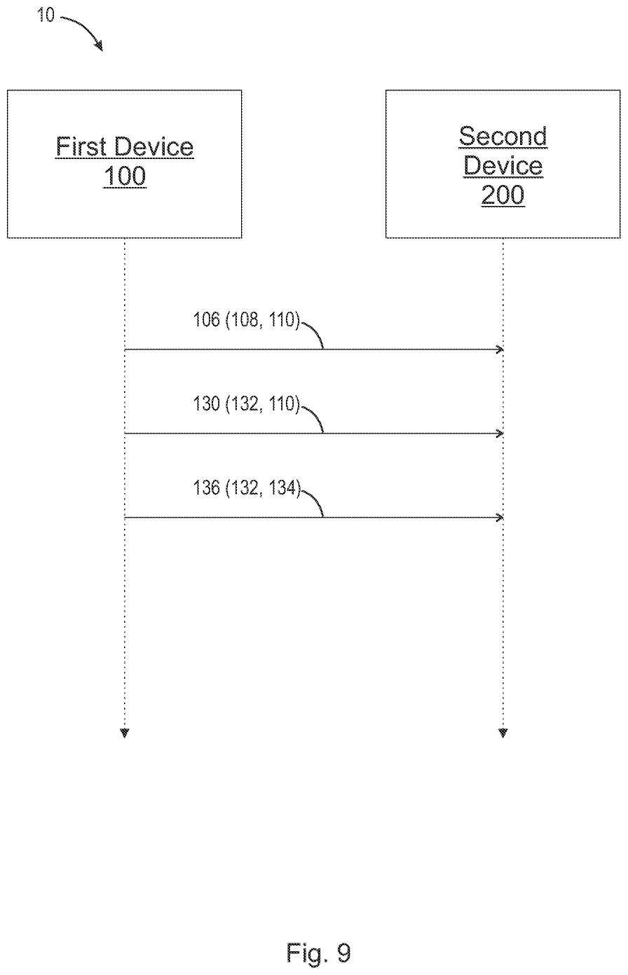

FIGS. 8 and 9 are flow diagrams illustrating some of the scenarios discussed with reference to FIGS. 6 and 7. In the embodiments of FIGS. 8 and 9, the first device 100 may be a wearable audio device (such as an audio headset) and the second device may be a central device (such as a smartphone). In other embodiments of FIGS. 8 and 9, the first device 100 may be a central device (such as an in-vehicle computing system) and the second device may be a wearable audio device (such as a pair of wireless ear buds).

In FIG. 8, the first device 100 wirelessly transmits a first data packet 106 (such as the data packet 106 shown in FIG. 5). The data packet 106 includes an audio data set 108 and a sensor data set 110. The sensor data set 110 may correspond to a motion sensor or other non-audio sensor. The audio data 108 has a first lifetime 124 of 10 milliseconds, while the sensor data 110 has a second lifetime 126 of 15 milliseconds. The first data packet 106 is received by the second device 200. In response, the second device 200 transmits an audio data acknowledgment 128 to the first device 100. The first device 100 then transmits a second data packet 130 with only the sensor data 110, as the second device 200 has already acknowledged receiving the audio data set 108.

In FIG. 9, the first device 100 again wirelessly transmits a first data packet 106 including an audio data set 108 and a sensor data set 110. The first device 100 then generates a second data packet 130 after the first lifetime 124 has expired, but before the second lifetime 126 has expired. Accordingly, the second data packet 130 includes a second audio data set 132 and the first sensor data set 110. The first device 100 then generates a third data packet 136 after both the first and second lifetimes 124, 126 have expired. Accordingly, the third data packet 136 includes a second audio data set 132 and the second sensor data set 134. As time progresses, new audio and sensor data will be cycled into the transmitted data packets according to the lifetimes 124, 126 of the data.

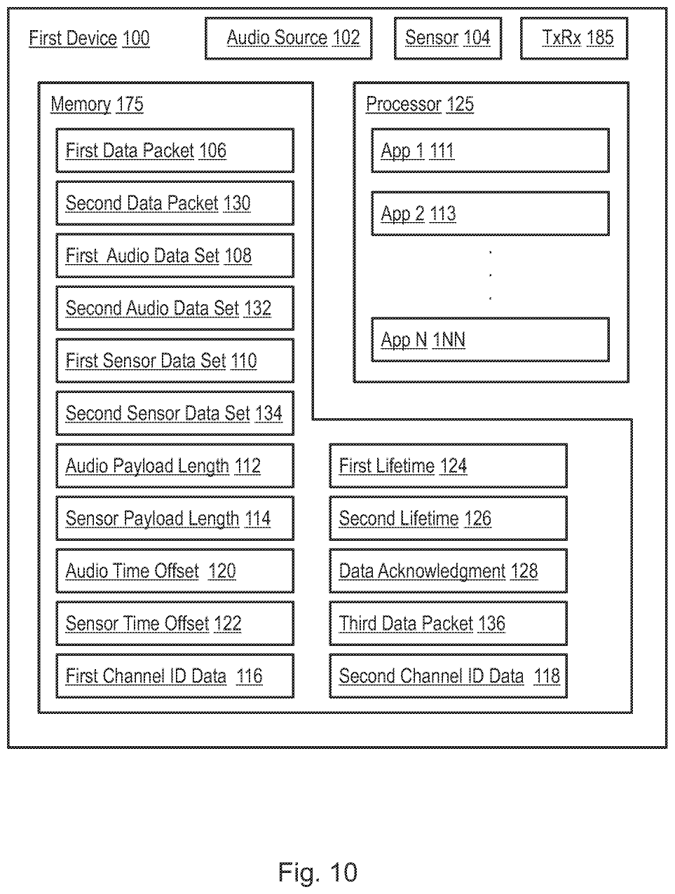

FIG. 10 schematically illustrates one of the first devices 100 previously depicted in FIGS. 1 and 2. The first device 100 may be a wearable audio device as shown in FIG. 1, or the first device may be a central device as shown in FIG. 2. As shown in the non-limiting examples of FIG. 1, the first device 100 may be embodied as an in-the-ear headphone form factor, an eyeglass form factor, or an over-the-ear headset. As shown in the non-limiting example of FIG. 2, the first device 100 may also be embodied as an in-vehicle computing system. The first device 100 includes the audio source 102, the sensor 104, the processor 125, the memory 175, and the transceiver 185. The audio source 102 may be embodied as a microphone to capture audio or a hardware or software interface to receive audio information. The memory 175 is configured to store the first data packet 106, the second data packet 130, the first audio data set 108, the second audio data set 132, the first sensor data set 110, the second sensor data set 134, the audio payload length 112, the sensor payload length 114, the first channel identification data 116, the second channel identification data 118, the audio time offset data 120, the sensor time offset data 122, the first data lifetime 124, the second data lifetime 126, the data acknowledgement 128, and the third data packet 136. The processor 125 is configured to execute one or more applications, such as app 1 111, app 2 113, through app N 1NN as shown in FIG. 3. In a non-limiting example, the processor 125 may be configured to multiplex the first audio data set 108 and the first sensor data set 110 to create the first data packet 106.

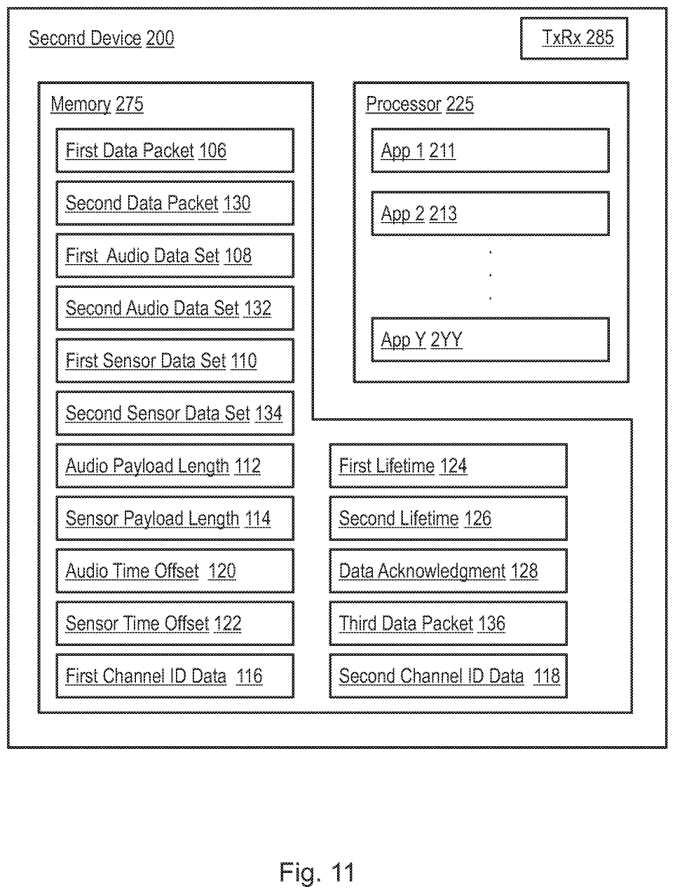

FIG. 11 schematically illustrates the second device 200 previously depicted in FIGS. 1 and 2. As shown in the non-limiting example of FIG. 1, the second device 200 may be a smartphone. As shown in the non-limiting example of FIG. 2, the second device 200 may be a pair of wireless earbuds. The second device 200 includes the processor 225, the memory 275, and the transceiver 285. The memory 275 is configured to store the first data packet 106, the second data packet 130, the first audio data set 108, the second audio data set 132, the first sensor data set 110, the second sensor data set 134, the audio payload length 112, the sensor payload length 114, the first channel identification data 116, the second channel identification data 118, the audio time offset data 120, the sensor time offset data 122, the first data lifetime 124, the second data lifetime 126, the data acknowledgement 128, and the third data packet 136. The processor 225 is configured to execute one or more applications, such as app 1 211, app 2 213, through app Y 2YY as shown in FIG. 3. In a non-limiting example, the processor 225 may be configured to demultiplex the first data packet 106 to reconstruct the first audio data set 108 and the first sensor data set 110 for further processing.

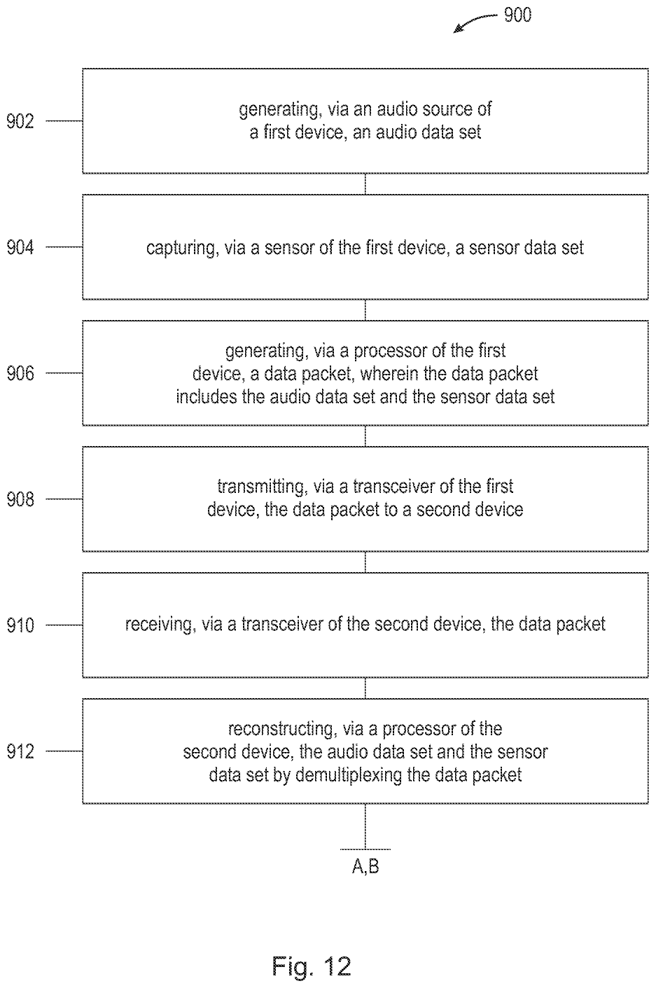

FIGS. 12-14 are flow charts of a method 900 for transmitting data, according to various embodiments of the invention. Referring to FIGS. 1-14, the method 900 includes, in step 902, generating, via an audio source 102 of a first device 100, an audio data set 108.

The method 900 further includes, in step 904, capturing, via a sensor 104 of the first device 100, a sensor data set 110.

The method 900 further includes, in step 906, generating, via a processor 125 of the first device 100, a data packet 106. The data packet 106 includes the audio data set 108 and the sensor data set 110. According to an example, the data packet 106 may further include audio payload length data 112 and/or sensor payload length data 114. According to another example, the data packet 106 may further include audio channel identification data 116 and/or sensor channel identification data 118. According to a further example, the data packet 106 may further include audio time offset data 120 and/or sensor time offset data 122. According to even further examples, the audio data set 108 has a first lifetime 124 and the sensor data set 110 has a second lifetime 126 longer than the first lifetime 124.

The method 900 further includes, in step 908, transmitting, via a transceiver 185 of the first device 100, the data packet 106 to a second device 200. According to an example, the data packet 106 may be transmitted via a Bluetooth Connected Isochronous Stream or a Bluetooth Broadcast Isochronous Stream.

The method 900 further includes, in step 910, receiving, via a transceiver 285 of the second device 200, the data packet 106.

The method 900 further includes, in step 912, reconstructing, via a processor 225 of the second device 200, the audio data set 108 and the sensor data set 110 by demultiplexing the data packet 106.

According to an example, the method 900 may further include, in optional steps 914, 916, and 918, respectively, (1) receiving, via the transceiver 185 of the first device 100, an audio data acknowledgment 128 prior to the first lifetime 124 expiring; (2) generating, via the processor 125 of the first device 100, a second data packet 130 including the sensor data set 110; and (3) transmitting, via the transceiver 185 of the first device 100, the second data packet 130 to the second device 200.

According to an example, the method 900 may further include, in optional steps 920, 922, 924, respectively, (1) generating, via the audio source 102 after the audio data set 108 expires, a second audio data set 132; (2) generating, via the processor 125 of the first device 100, a second data packet 130 including the second audio data set 132 and the sensor data set 110; and (3) transmitting, via the transceiver 185 of the first device 100, the second data packet 130 to the second device 200. Further to this example, the method 900 may further include, in optional steps 926, 928, and 930, respectively, (1) capturing, via the sensor 926 of the first device 100 after the sensor data set 110 expires, a second sensor data set 134; (2) generating, via the processor 125 of the first device 100, a third data packet 136 including the second audio data set 132 and the second sensor data set 134; and (3) transmitting, via the transceiver 185 of the first device 100, the third data packet 136 to the second device 200.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A first device, comprising:
an audio source configured to generate audio data;
a sensor configured to capture sensor data; and
a processor configured to:
generate a data packet, wherein the data packet includes an audio data set generated by the audio source and a sensor data set captured by the sensor; and
transmit the data packet to a second device, wherein the second device is configured to reconstruct the audio data set and the sensor data set by demultiplexing the data packet.

2. The first device of claim 1, wherein the first device is a wearable audio device, and wherein the second device is a central device.

3. The first device of claim 1, wherein the first device is a central device, and wherein the second device is a wearable audio device.

4. The first device of claim 1, wherein the data packet further comprises audio payload length data and/or sensor payload length data.

5. The first device of claim 1, wherein the data packet further comprises audio channel identification data and/or sensor channel identification data.

6. The first device of claim 1, wherein the data packet further comprises audio time offset data and/or sensor time offset data.

7. The first device of claim 1, wherein the sensor is an inertial measurement unit (IMU), and wherein the sensor data is motion data.

8. The first device of claim 1, wherein the data packet is transmitted via a Bluetooth Connected Isochronous Stream or a Bluetooth Broadcast Isochronous Stream.

9. The first device of claim 1, wherein the audio data set has a first lifetime and the sensor data set has a second lifetime longer than the first lifetime, and wherein the processor is further configured to:
receive an audio data acknowledgment prior to the first lifetime expiring;
generate a second data packet including the sensor data set; and
transmit the second data packet to the second device.

10. The first device of claim 1, wherein the audio data set has a first lifetime and the sensor data set has a second lifetime longer than the first lifetime, and wherein the processor is further configured to:
generate, via the audio source after the audio data set expires, a second audio data set;
generate, via the processor of the first device, a second data packet including the second audio data set and the sensor data set; and
transmit the second data packet to the second device.

11. The first device of claim 10, wherein the processor is further configured to:
capture, via the sensor of the first device after the sensor data set expires, a second sensor data set;
generate a third data packet including the second audio data set and the second sensor data set; and
transmit the third data packet to the second device.

12. A method for transmitting data, comprising:
generating, via an audio source of a first device, an audio data set;
capturing, via a sensor of the first device, a sensor data set;
generating, via a processor of the first device, a data packet, wherein the data packet includes the audio data set and the sensor data set;
transmitting, via a transceiver of the first device, the data packet to a second device;
receiving, via a transceiver of the second device, the data packet; and
reconstructing, via a processor of the second device, the audio data set and the sensor data set by demultiplexing the data packet.

13. The method of claim 12, wherein the data packet further comprises audio payload length data and/or sensor payload length data.

14. The method of claim 12, wherein the data packet comprises audio channel identification data and/or sensor channel identification data.

15. The method of claim 12, wherein the data packet further comprises audio time offset data and/or sensor time offset data.

16. The method of claim 12, wherein the data packet is transmitted via a Bluetooth Connected Isochronous Stream or a Bluetooth Broadcast Isochronous Stream.

17. The method of claim 12, wherein the audio data set has a first lifetime and the sensor data set has a second lifetime longer than the first lifetime.

18. The method of claim 17, further comprising:
receiving, via the transceiver of the first device, an audio data acknowledgment prior to the first lifetime expiring;
generating, via the processor of the first device, a second data packet including the sensor data set; and
transmitting, via the transceiver of the first device, the second data packet to the second device.

19. The method of claim 17, further comprising:
generating, via the audio source after the audio data set expires, a second audio data set;
generating, via the processor of the first device, a second data packet including the second audio data set and the sensor data set; and
transmitting, via the transceiver of the first device, the second data packet to the second device.

20. The method of claim 19, further comprising:
capturing, via the sensor of the first device after the sensor data set expires, a second sensor data set;
generating, via the processor of the first device, a third data packet including the second audio data set and the second sensor data set; and
transmitting, via the transceiver of the first device, the third data packet to the second device.
